(19) United States
(12) Patent Application Publication
(10) Pub. No.: US 2025/0306708 A1
(43) Pub. Date: Oct. 2, 2025

(54) TOUCHSCREEN SIGNAL RECOGNITION METHOD, APPARATUS, AND ELECTRONIC DEVICE

(71) Applicant: Lenovo (Beijing) Limited, Beijing (CN)

(72) Inventor: Hongna ZHANG, Beijing (CN)

(21) Appl. No.: 19/087,488

(22) Filed: Mar. 22, 2025

(30) Foreign Application Priority Data
Mar. 29, 2024 (CN) 202410381766.2

(51) Int. Cl. G06F 3/041; G06F 3/044

(52) U.S. Cl. CPC G06F 3/041662; G06F 3/0446

(57) ABSTRACT

A touchscreen signal recognition method includes, within a scanning cycle, in response to a first scanning instruction, recognizing a touch signal on a touchscreen in a first scanning mode, within the same scanning cycle, in response to a second scanning instruction, determining whether the touch signal of the touchscreen has a corresponding ground signal in a second scanning mode, and in response to a trigger area of the touch signal meeting a preset condition, and the touch signal corresponding to the ground signal, determining the touch signal as a target signal.

### CROSS-REFERENCE TO RELATED APPLICATION

The present disclosure claims priority to Chinese Patent Application No. 202410381766.2, filed on Mar. 29, 2024, the entire content of which is incorporated herein by reference.

### TECHNICAL FIELD

The present disclosure is related to the touch control technology field and, more particularly, to a touchscreen signal recognition method, a touchscreen signal recognition apparatus, and an electronic device.

### BACKGROUND

A passive-type stylus changes the capacitance of a touchscreen through contact between a conductive material and the touchscreen to display content on the touchscreen. For the stylus with a small tip and poor conductivity, when writing on a touchscreen with a large size, the stylus draws broken lines or is unable to draw. The main reason is that the signal amount generated when this type of stylus is used is small and is prone to interference by fingers, watermarks, and environmental noises. Thus, the writing performance is poor. Therefore, the existing touchscreens with a large size usually support passive-type styluses with large tips.

### SUMMARY

An aspect of the present disclosure provides a touchscreen signal recognition method. The method includes, within a scanning cycle, in response to a first scanning instruction, recognizing a touch signal on a touchscreen in a first scanning mode, within the same scanning cycle, in response to a second scanning instruction, determining whether the touch signal of the touchscreen has a corresponding ground signal in a second scanning mode, and in response to a trigger area of the touch signal meeting a preset condition, and the touch signal corresponding to the ground signal, determining the touch signal as a target signal.

An aspect of the present disclosure provides a touchscreen signal recognition apparatus, including a first scanning module, a second scanning module, and a determination module. The first scanning module is configured to, within a scanning cycle, in response to a first scanning instruction, recognize a touch signal of a touchscreen in a first scanning mode. The second scanning module is configured to, within the same scanning cycle, in response to a second scanning instruction, determine whether the touch signal of the touchscreen has a corresponding ground signal in a second scanning mode. The determination module is configured to, in response to a trigger area of the touch signal meeting a preset condition, and the touch signal having the corresponding ground signal, determine the touch signal as a target signal.

An aspect of the present disclosure provides an electronic device, including one or more processors, and one more memories. The one or more memories are communicatively connected to the one or more processors and store an instruction executable by the one or more processors that, when executed by the one or more processors, causes the one or more processors to, within a scanning cycle, in response to a first scanning instruction, recognize a touch signal on a touchscreen in a first scanning mode, within the same scanning cycle, in response to a second scanning instruction, determine whether the touch signal of the touchscreen has a corresponding ground signal in a second scanning mode, and in response to a trigger area of the touch signal meeting a preset condition, and the touch signal corresponding to the ground signal, determine the touch signal as a target signal.

### BRIEF DESCRIPTION OF THE DRAWINGS

FIG. 1 is a schematic flowchart of a touchscreen signal recognition method according to some embodiments of the present disclosure.

FIG. 2 is a schematic structural diagram of a touchscreen according to some embodiments of the present disclosure.

FIG. 2A is a schematic structural diagram showing a connection between a sensor circuit and a ground wire according to some embodiments of the present disclosure.

FIG. 2B is a schematic structural diagram of a sensor node according to some embodiments of the present disclosure.

FIG. 3 is a schematic flowchart of recognizing whether a touch signal of a touchscreen corresponds to a grounding signal according to some embodiments of the present disclosure.

FIG. 4 is a schematic flowchart of a first operation mode and an implementation of the first operation mode according to some embodiments of the present disclosure.

FIG. 5 is a schematic structural diagram of a touchscreen signal recognition apparatus according to some embodiments of the present disclosure.

FIG. 6 is a schematic structural diagram of an electronic device according to some embodiments of the present disclosure.

### DETAILED DESCRIPTION OF THE EMBODIMENTS

To make the purpose, features, and advantages of the present disclosure more obvious and easier to understand, the technical solutions of embodiments of the present disclosure are described in detail in conjunction with the accompanying drawings of embodiments of the present disclosure. Obviously, the described embodiments are some embodiments of the present disclosure, and not all embodiments of the present disclosure. Based on embodiments of the present disclosure, all other embodiments obtained by those skilled in the art without creative effort are within the scope of the present disclosure.

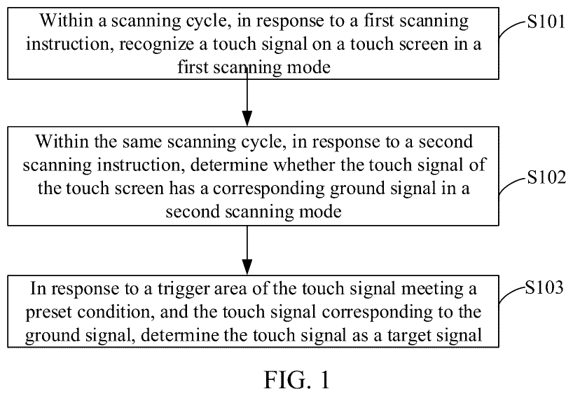

The present disclosure provides a touchscreen signal recognition method. As shown in FIG. 1, the method includes the following processes.

At 101, within a scanning cycle, in response to a first scanning instruction, a touch signal on a touchscreen is recognized in a first scanning mode.

In some embodiments, the scanning cycle can refer to a time period during which the touchscreen scans at a certain period to detect a signal, which is consistent with a refresh frequency of the touchscreen. Within a scanning cycle, in response to a first scanning instruction that is received, a touchscreen controller can perform scanning on the touchscreen in the first scanning mode to recognize the touch signal on the touchscreen.

The touchscreen controller can be a control circuit module that can convert a user touch operation into a digital signal and communicate with a computer processing system or another device module. In the present disclosure, the touchscreen controller can be mainly configured to periodically emit an excitation signal (voltage or current) according to the scanning method indicated by the scanning instruction within the scanning cycle, detect and recognize an electrical signal (i.e., touch signal) that changes due to the touch operation of the user on the touchscreen.

The touchscreen controller can be further configured to convert the information carried by the electrical signal into a digital signal and then upload the information to a central processing system for analysis and processing by the central processing system. The information carried by the electrical signal can include a touch area and position information corresponding to the signal.

At 102, within a same scanning cycle, in response to a second scanning instruction, whether the touch signal on the touchscreen corresponds to a ground signal is recognized in a second scanning mode.

In some embodiments, within the same scanning cycle as the above, in response to receiving a second scanning instruction, the touchscreen controller can perform scanning on the touchscreen in the second scanning mode to identify whether the touch signal on the touchscreen corresponds to a ground signal. Although the conductive media that trigger the touch signal and the ground signal corresponding to the touch signal are the same, since the scanning methods are different, the touch signal and the ground signal can be different signals.

At 103, if a trigger area of the touch signal satisfies a preset condition, and the touch signal corresponds to the ground signal, the touch signal is determined as a target signal.

In some embodiments, various conductive media can trigger the touch signal on the touchscreen and can include not only conventional touch conductors such as fingers and passive touch conductors (e.g., passive-type stylus and pencil), but also potential interference factors such as water droplets and environmental noise. A difference between the touch conductor and the interference factor can include whether the conductive medium is grounded. Therefore, the touchscreen controller can perform scanning on the touchscreen in the second scanning mode to recognize whether the touch signal corresponds to the ground signal to exclude the touch signal generated by an interference factor.

Meanwhile, the touch areas where conductive media generate the touch signals can also be different. Therefore, the trigger area can be limited by setting the preset condition to filter out the touch signals with the touch areas satisfying the preset condition.

Thus, by performing the two times of filtering on the touch signals on the touchscreen, the touch signal corresponding to a ground signal and with the touch area satisfying the preset condition can be determined as the target signal.

In the touchscreen signal recognition method of the present disclosure, in one scanning cycle, in response to the first scanning instruction, the touch signal of the touchscreen can be recognized in the first scanning mode, and in response to the second scanning instruction, whether the touch signal of the touchscreen corresponds to the ground signal can be recognized in the second scanning mode. A preset condition can be set for the touch area of the touch signal. The touch signal with the ground signal can be further filtered to obtain the touch signal corresponding to the ground signal and with the touch area satisfying the preset condition. Thus, after two times of filtering, the touch signal obtained through filtering can be determined as the target signal to improve the recognition rate of the touchscreen for the touch signal with a small signal amount.

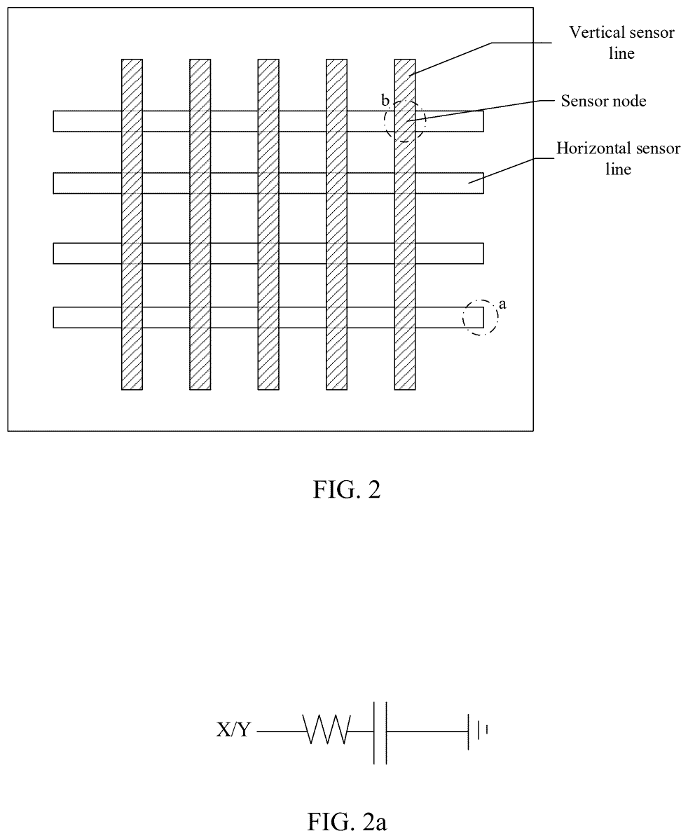

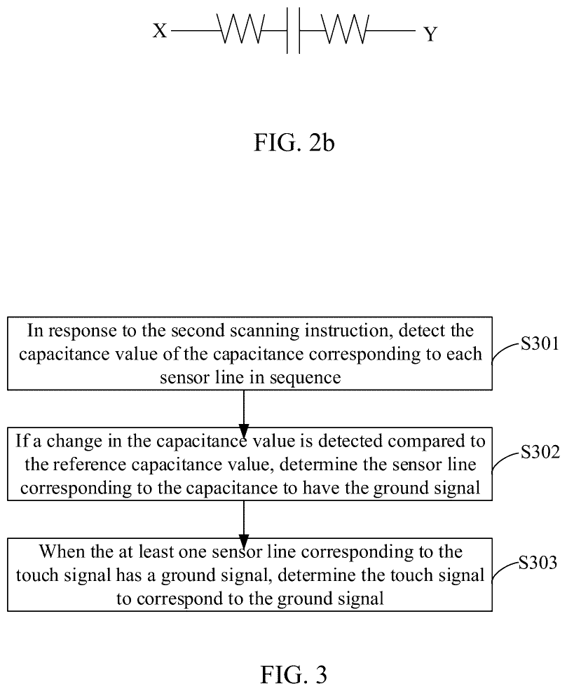

In some embodiments, FIG. 2 is a schematic structural diagram of a touchscreen according to some embodiments of the present disclosure. The touchscreen includes a plurality of horizontal sensor lines and a plurality of vertical sensor lines. Each horizontal sensor line and each vertical sensor line are connected to the ground line and have a capacitance with the ground line. An intersection between a horizontal sensor line and a vertical sensor line can be a sensor node.

FIG. 2A is a schematic structural diagram showing a connection between a sensor line and a ground line at enlarged position a of FIG. 2. FIG. 2B is a schematic structural diagram of a sensor node at enlarged position b of FIG. 2. X represents a horizontal sensor line, and Y represents a vertical sensor line.

In some embodiments, in a traditional mutual capacitance touchscreen, the horizontal sensor lines and the vertical sensor lines are usually directly grounded. However, in the present disclosure, as shown in FIG. 2A, although each horizontal sensor line and each vertical sensor line in the touchscreen are connected to the ground line, the horizontal sensor lines and the vertical sensor lines are not directly connected to the ground line but are connected by forming a capacitive structure between each sensor line and the ground line.

As shown in FIG. 2B, a sensor node formed by the intersection of each horizontal sensor line and each vertical sensor line is also a capacitive structure.

In some embodiments, the first scanning mode can be mutual capacitance scanning, and the second scanning mode can be self-capacitance scanning.

In some embodiments, in the first scanning mode, i.e., mutual capacitance scanning, the touchscreen controller can sequentially provide excitation signals to the horizontal sensor lines in a predetermined order and scan the vertical sensor lines one by one to detect the capacitance changes at the sensor nodes between the vertical sensor lines and the excited horizontal sensor lines. When a touch conductor or other interference contacts the touchscreen, the reference capacitance value of the sensor node can be changed. When the touchscreen controller performs mutual capacitance scanning, if a change in the capacitance value of the sensor node is measured compared to the reference capacitance value of the sensor node, the touch signal can be determined at the sensor node.

In the second scanning mode, i.e., the self-capacitance scanning, each sensor line (no matter a horizontal sensor line or a vertical sensor line) can operate independently. Thus, the touchscreen controller can send excited signals to each sensor line in sequence while detecting the capacitance change between the excited sensor line and the ground line.

In some embodiments, within the scanning cycle, in response to the scanning instruction, the first scanning mode and the second scanning mode can be executed in sequence, or the second scanning mode and the first scanning mode can be executed in sequence.

In some embodiments, since the first scanning mode and the second scanning mode are fundamentally different, the touchscreen controller cannot execute both scanning methods simultaneously within a scanning cycle and may need to execute both scanning methods in sequence. However, the execution order is not limited by the present disclosure. Within a scanning cycle, in response to the scanning instruction, the first scanning mode and the second scanning mode can be executed in sequence, or the second scanning mode and the first scanning mode can also be executed in sequence. With both orders of scanning methods may not change the finally determined target signal.

In some embodiments, as shown in FIG. 3, the implementation process of recognizing whether the touch signal of the touchscreen corresponds to the ground signal in the second scanning mode includes the following processes.

At 301, in response to the second scanning instruction, the capacitance value of the capacitance corresponding to each sensor line is detected in sequence.

In some embodiments, the touchscreen controller, in response to the second scanning instruction, can send the excitation signals to each sensor line in sequence while detecting the capacitance value of the capacitance between the excited sensor line and the ground line.

At 302, if a change in the capacitance value is detected compared to the reference capacitance value, the sensor line corresponding to the capacitance is determined to have the ground signal.

In some embodiments, when a grounded touch conductor contacts the touchscreen, the capacitance corresponding to the relevant sensor line can be changed. Therefore, if the touchscreen controller detects a change in the capacitance value of the sensor line compared to the reference capacitance value, the sensor line can be determined to have a ground signal.

Since the interference signal (e.g., water droplets, environmental noise, and other non-grounded conductive media) cannot be grounded, the capacitance value between the sensor line and the ground line may not be changed. Thus, the ground signal cannot be detected.

At 303, when the at least one sensor line corresponding to the touch signal has a ground signal, the touch signal is determined to correspond to the ground signal.

In some embodiments, based on the trigger area and position information corresponding to the touch signal, a plurality of sensor lines triggered by the touch signal can be determined. According to the detection in steps 301 and 302, if the at least one sensor line corresponding to the touch signal is detected to have a ground signal, the touch signal can be determined to correspond to the ground signal.

For example, the touchscreen sensor can detect the coordinates of the trigger area corresponding to the touch signal in the first scanning mode (mutual capacitance scanning) as:
(X1, Y1), (X2, Y1), (X3, Y1)
(X1, Y2), (X2, Y2), (X3, Y2)
(X1, Y3), (X2, Y3), (X3, Y3)
   where Xi represents an i-th horizontal sensor line, and Yj represents a j-th vertical sensor line.

When the touchscreen sensor detects that second vertical sensor line Y2 and the third horizontal sensor line X3 have ground signals in the second scanning mode (self-capacitance scanning), the touch signal can be determined to have a corresponding ground signal.

In some embodiments, when a number of sensor nodes included in the trigger area is less than a preset number, the trigger area of the touch signal may satisfy the preset condition.

In the same touchscreen, the touch area corresponding to the touch signal triggered by a finger can be larger than the touch area corresponding to the touch signal triggered by a passive-type stylus (tip). In a traditional scanning method, the touchscreen controller usually sets the touch signal triggered by the finger as a target signal and ignores the touch signal triggered by the passive-type stylus.

Therefore, in some embodiments, the preset condition that needs to be satisfied by the trigger area can include the number of the sensor nodes included in the trigger area being less than the preset number. Then, the touch signal triggered by the touch conductor with a large trigger area can be excluded, and the touch signal triggered by the touch conductor with a small trigger area can be retained. The preset number can be set according to the size of the tip of the passive-type stylus, which is not limited in the present disclosure. The type of the operator can be determined according to the size of the trigger area, for example, a finger or a stylus tip. The operator and the corresponding target signal can be recognized according to the size of the trigger area.

In addition, besides setting the preset condition as the number of the sensor nodes included in the trigger area being less than the preset number, the preset condition of the touch signal can further include a number of the sensor lines included in the trigger area being smaller than the present number. Similarly, the present number of sensor lines may not be limited in the present disclosure.

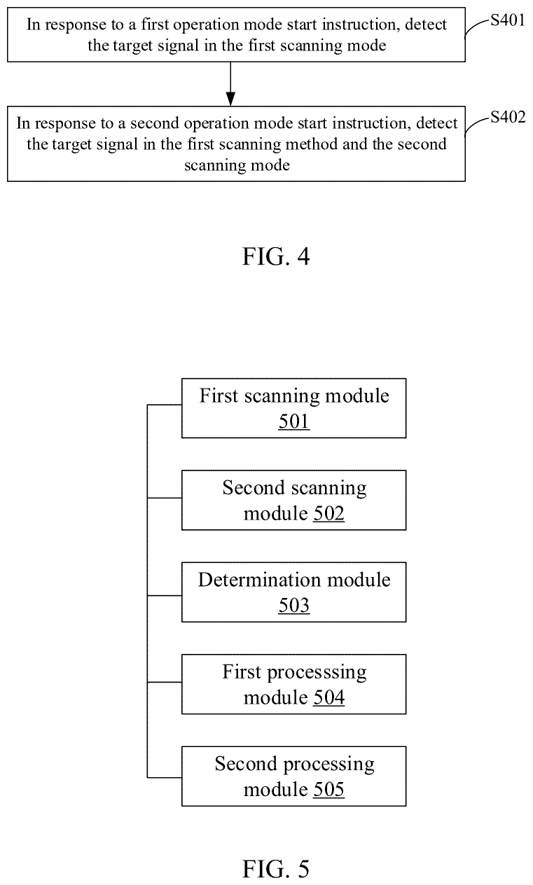

In some embodiments, as shown in FIG. 4, the method further includes the following processes.

At 401, in response to a first operation mode start instruction, the target signal is detected in the first scanning mode.

In some embodiments, in response to the first operation mode start instruction, the touchscreen controller can detect the touch signal on the touchscreen only in the first scanning mode within a scanning cycle. The first operation mode can be a conventional operation mode of the touchscreen and can be suitable for detecting the touch signal triggered by the touch conductor with a large trigger area (or a large signal amount).

At 402, in response to a second operation mode start instruction, the target signal is detected in the first scanning mode and the second scanning mode.

In some embodiments, in response to the second operation mode start instruction, the touchscreen controller can detect the target signal in the two scanning methods of the first scanning mode and the second scanning mode within one scanning cycle. The second operation mode can be more suitable for detecting the touch signal triggered by the touch conductor with a small trigger area (or a small signal amount).

In some embodiments, the method can further include, when the current operation mode is not the second operation mode and the change amount of the capacitance value is detected to be smaller than the signal of the threshold, issuing the second operation mode start instruction or obtaining the second operation mode start instruction through the user interface.

In some embodiments, when the current operation mode of the touchscreen is not the second operation mode but the first operation mode or another operation mode, if the change amount of the capacitance value of the touch signal is detected to be smaller than the threshold, the touch signal may be generated by the touch of the passive touch conductor with a small tip. Then, the second operation mode instruction can be issued, and the current operation mode of the touchscreen can be switched to the second operation mode to determine whether the touch signal has the ground signal and whether the trigger area satisfies the preset condition. If the touch signal has the ground signal and the trigger area satisfies the preset condition, the trigger signal can be determined as the target signal, and the touch signal can be analyzed and processed subsequently. Thus, the recognition rate of the touchscreen for the touch signal with a small signal amount can be improved, meanwhile the user operation can be reduced to improve the user experience.

In addition, the second operation mode start instruction can also be obtained through a user interface.

In some embodiments, when the current operation mode of the touchscreen is not the first operation mode but the second operation mode or another operation mode, if touch signals with larger signal amounts are continuously detected on the touchscreen, the first operation mode start instruction can be issued to switch the current operation mode of the touchscreen to the first operation mode. Then, the power consumption of the touchscreen can be saved while the user operations can be reduced, and the user experience can be increased. In addition, the first operation mode start instruction can also be obtained through the user interface.

The present disclosure also provides a touchscreen signal recognition apparatus. As shown in FIG. 5, the apparatus includes a first scanning module 501, a second scanning module 502, and a determination module 503.

The first scanning module 501 can be configured to, within a scanning cycle, in response to the first scanning instruction, recognize the touch signal on the touchscreen in the first scanning mode.

The second scanning module 502 can be configured to, within the same scanning cycle, in response to the second scanning instruction, recognize whether the touch signal of the touchscreen corresponds to a ground signal in the second scanning mode.

The determination module 503 can be configured to, if the trigger area of the touch signal satisfies the preset condition, and the touch signal corresponds to the ground signal, determine the trigger signal as the target signal.

In some embodiments, the first scanning mode can be the mutual capacitance scanning method, and the second scanning mode can be the self-capacitance scanning method.

In some embodiments, within the scanning cycle, in response to the scanning instruction, the first scanning mode and the second scanning mode can be executed in sequence, or the second scanning mode and the first scanning mode can be executed in sequence.

In some embodiments, the touchscreen can include a plurality of horizontal sensor lines and a plurality of vertical sensor lines. Each horizontal sensor line and each vertical sensor line are connected to the ground line and have a capacitance with the ground line. An intersection between a horizontal sensor line and a vertical sensor line can be a sensor node.

In some embodiments, the second scanning module 502 can be configured to, in response to the second scanning instruction, detect the capacitance value of the capacitor corresponding to each sensor line in sequence, if the change in the capacitance value is detected compared to the reference capacitance value, determine that the sensor line corresponding to the capacitance has the ground signal, and when the at least one sensor line corresponding to the touch signal has the ground signal, determine that the touch signal corresponds to the ground signal.

In some embodiments, when the number of the sensor nodes included in the trigger area is less than the preset number, the trigger area of the touch signal can satisfy the preset condition.

In some embodiments, as shown in FIG. 5, the apparatus further includes the first processing module 504. The first processing module 504 is configured to, in response to the first operation mode start instruction, detect the target signal in the first scanning mode, and in response to the second operation mode start instruction, detect the target signal in the first scanning mode and the second scanning mode.

In some embodiments, as shown in FIG. 5, the apparatus further includes a second processing module 505. The second processing module 505 can be configured to, when the current operation mode is not the second operation mode, and the change amount of the capacitance value is detected to be less than the signal of the threshold, issue the second operation mode start instruction, or obtain the second operation mode start instruction through the user interface.

In some embodiments, the present disclosure further provides an electronic device and a readable storage medium.

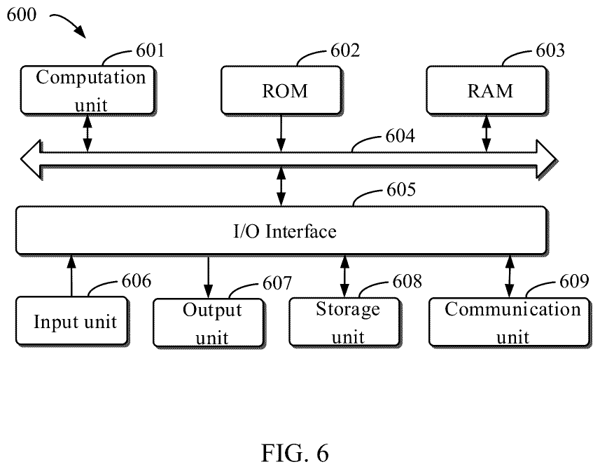

FIG. 6 is a schematic structural diagram of an electronic device 600 according to some embodiments of the present disclosure. The electronic device is intended to represent various digital computers, e.g., laptop computers, desktop computers, operation platforms, personal digital assistants, servers, blade servers, large computers, and other suitable computers. The electronic device can also represent various mobile apparatuses, such as personal digital processors, cellular phones, smartphones, wearable devices, and other similar computing apparatuses. The members, the connection and relationship of the members, and the functions of the members in the present disclosure are merely examples and are not intend to limit the description of the present disclosure and/or the implementation of the present disclosure.

As shown in FIG. 6, the electronic device 600 includes a computation unit 601. According to the computer program stored in the read-only memory (ROM) 602 or the computer program loaded from the storage unit 608 to the random access memory (RAM) 603, the computation unit 601 can perform various suitable actions and processing. In RAM 603, various programs and data required by the operation of the device 600 can be stored. The computation unit 601, ROM 602, and RAM 603 can be connected to each other through the bus 604. The input/output (I/O) interface 605 is also connected to the bus 604.

A plurality of members of the device 600 can be connected to the I/O interface 605 and include an input unit 606, e.g., a keyboard, a mouse, etc., an output unit 607, e.g., various monitors, speakers, etc., the storage unit 608, e.g., magnetic tapes, optical disks, etc., and a communication unit 609, e.g., a network card, a modem, a wireless communication transceiver, etc. The communication unit 609 can allow the device 600 to exchange information/data with another device through the computer network, such as the internet, and/or various communication networks.

The computation unit 601 can be a general and/or special assembly having the processing and computation abilities. In some embodiments, the computation unit 601 can include but is not limited to central processing units (CPUs), graphics processing units (GPUs), various specialized artificial intelligence (AI) computing chips, various computing units running machine learning model algorithms, digital signal processors (DSPs), and any appropriate processors, controllers, microcontrollers, etc. The computation unit 601 can execute the various methods and processing described above, such as the touchscreen signal recognition method. For example, in some embodiments, the touchscreen signal recognition method can be implemented as a computer software program, which is tangibly contained in a machine-readable medium, such as the storage unit 608. In some embodiments, a part or all of the computer program can be loaded and/or installed onto device 600 via ROM 602 and/or a communication unit 609. When the computer program is loaded into RAM 603 and executed by the computation unit 601, one or more steps of the touchscreen signal recognition method described above can be executed. Alternatively, in other embodiments, the computation unit 601 can be configured to execute the touchscreen signal recognition method in any other appropriate methods (e.g., with firmware).

The various implementations of the systems and technologies described above can be implemented in digital electronic circuit systems, integrated circuit systems, field-programmable gate arrays (FPGAs), application-specific integrated circuits (ASICs), application-specific standard products (ASSPs), system-on-chip systems (SOCs), complex programmable logic devices (CPLDs), computer hardware, firmware, software, and/or combinations thereof. In these various implementations, the method can be implemented in one or more computer programs. The one or more computer programs can be executed and/or interpreted on a programmable system including at least one programmable processor. The programmable processor can be a special-purpose or general-purpose programmable processor, can receive data and instructions from a storage system, at least one input apparatus, and at least one output apparatus, and transmit the data and instructions to the storage system, the at least one input apparatus, and the at least one output apparatus.

Program codes for implementing the method of the present disclosure can be written in any combination of one or more programming languages. These program codes can be provided to a processor or controller of a general-purpose computer, special-purpose computer, or other programmable data processing apparatus. Thus, when the program codes are executed by the processor or controller, the functions/operations specified in the flowcharts and/or block diagrams can be implemented. The program codes can be executed entirely on a machine, partly on a machine, partly on a machine and partly on a remote machine, or entirely on a remote machine or server as an individual software packet.

In the context of the present disclosure, the machine-readable medium can be a tangible medium that can include or store a program for use by or in connection with an instruction execution system, apparatus, or device. The machine-readable medium can be a machine-readable signal medium or a machine-readable storage medium. The machine-readable medium can include but is not limited to electronic, magnetic, optical, electromagnetic, infrared, or semiconductor systems, apparatuses, or devices, or any suitable combination of thereof. More specific examples of the machine-readable storage medium can include electrical connections based on one or more wires, portable computer disks, hard drives, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination thereof.

To provide interaction with a user, the systems and technologies described herein can be implemented on a computer. The computer can include a display apparatus (e.g., a CRT (cathode ray tube) or LCD (liquid crystal display) monitor) for displaying information to the user, and a keyboard and pointing apparatus (e.g., a mouse or trackball). The user can provide the input to the computer through the keyboard and the pointing apparatus. Other types of apparatuses can be further configured to provide interactions with the user. For example, the feedback provided to the user can be any types of sensor feedbacks (e.g., visual feedback, auditory feedback, or tactile feedback). The input from the user can be received in any form, including acoustic input, voice input, or tactile input.

The systems and technologies described herein can be implemented in a computation system that includes a back-end member (e.g., a data server), or a computation system including a middleware member (e.g., an application server), or a computation system that includes a front-end member (e.g., a user computer with graphical user interfaces or web browsers, users can interact with implementations of the systems and technologies described herein through the user computer with graphical user interfaces or web browsers), or a computation system including any combination of such back-end, middleware, or front-end member. The members of the system can be interconnected by any form or medium of digital data communication (e.g., a communication network). Examples of the communication network can include a local area network (LAN), a wide area network (WAN), and the Internet.

A computer system can include a client and a server. The client and the server can be generally away from each other and interact with each other through the communication network. The relationship between the client and the server can be generated by running a computer program having the client-server relationship on the corresponding computer. The server can be a cloud server, a server of a distributed system, or a server combined with blockchain.

Various forms of processes above can be used with steps reordered, added, or removed. For example, the steps described in the present disclosure can be executed in parallel, in sequence, or in a different order, as long as the desired results of the technical solutions of the present disclosure can be achieved, which is not limited here.

In addition, the terms “first” and “second” are used for descriptive purposes only and cannot be understood as indicating or implying relative importance or implicitly indicating the number of the technical features. Thus, features defined with “first” and “second” can explicitly or implicitly include at least one of the features. In the description of the present disclosure, “a plurality of” means two or more, unless otherwise explicitly and specifically defined.

The above are only some embodiments of the present disclosure, but the scope of the present disclosure is not limited to this. Those skilled in the art can easily think of changes or substitutions within the technical scope of the present disclosure. These changes or substitutions should be within the scope of the present disclosure. Therefore, the scope of the present disclosure should be subject to the scope of the claims.

What is claimed is:

1. A touchscreen signal recognition method comprising:
within a scanning cycle, in response to a first scanning instruction, recognizing a touch signal on a touchscreen in a first scanning mode;
within the same scanning cycle, in response to a second scanning instruction, determining whether the touch signal of the touchscreen has a corresponding ground signal in a second scanning mode; and
in response to a trigger area of the touch signal meeting a preset condition, and the touch signal corresponding to the ground signal, determining the touch signal as a target signal.

2. The method according to claim 1,
the first scanning mode is mutual capacitance scanning, and the second scanning mode is self-capacitance scanning.

3. The method according to claim 1, wherein within the scanning cycle, in response to a scanning instruction:
executing the first scanning mode and the second scanning mode in sequence; or
executing the second scanning mode and the first scanning mode in sequence.

4. The method according to claim 1, wherein:
the touchscreen includes a plurality of horizontal sensor lines and a plurality of vertical sensor lines;
each of the horizontal sensor lines and each of the vertical sensor lines are connected to a ground line and have a capacitance with the ground line; and
an intersection of a horizontal sensor line and a vertical sensor line is a sensor node.

5. The method according to claim 4, wherein determining whether the touch signal has the corresponding ground signal in the second scanning mode includes:
in response to the second scanning instruction, detecting a capacitance value of a capacitance corresponding to each sensor line of the horizontal sensor lines and the vertical sensor lines;
in response to detecting a change in the capacitance value compared to a reference capacitance value, determining that the sensor line corresponding to the capacitance has the ground signal; and
in response to at least one sensor line corresponding to the touch signal having a ground signal, determining that the touch signal has the corresponding ground signal.

6. The method according to claim 4, wherein when a number of sensor nodes included in the trigger area is less than a preset number, the trigger area of the touch signal meets a preset condition.

7. The method according to claim 1, further comprising:
in response to a first operation mode start instruction, detecting the target signal in the first scanning mode; and
in response to a second operation mode start instruction, detecting the target signal in the first scanning mode and the second scanning mode.

8. The method according to claim 7, further comprising:
in response to a current operation mode being not a second operation mode, and detecting that a change amount of the capacitance value is smaller than a threshold, issuing the second operation mode start instruction; or
obtaining the second operation mode start instruction through a user interface.

9. A touchscreen signal recognition apparatus comprising:
a first scanning module configured to, within a scanning cycle, in response to a first scanning instruction, recognize a touch signal of a touchscreen in a first scanning mode;
a second scanning module configured to, within the same scanning cycle, in response to a second scanning instruction, determine whether the touch signal of the touchscreen has a corresponding ground signal in a second scanning mode; and
a determination module configured to, in response to a trigger area of the touch signal meeting a preset condition, and the touch signal having the corresponding ground signal, determine the touch signal as a target signal.

10. The apparatus according to claim 9, wherein:
the first scanning mode is mutual capacitance scanning, and the second scanning mode is self-capacitance scanning.

11. The apparatus according to claim 9, wherein within the scanning cycle, in response to a scanning instruction:
the first scanning mode and the second scanning mode are executed in sequence; or
the second scanning mode and the first scanning mode are executed in sequence.

12. The apparatus according to claim 9, wherein:
the touchscreen includes a plurality of horizontal sensor lines and a plurality of vertical sensor lines;
each of the horizontal sensor lines and each of the vertical sensor lines are connected to a ground line and have a capacitance with the ground line; and
an intersection of a horizontal sensor line and a vertical sensor line is a sensor node.

13. An electronic device comprising:
one or more processors; and
one or more memories communicatively connected to the one or more processors and storing an instruction executable by the one or more processors that, when executed by the one or more processors, causes the one or more processors to:
within a scanning cycle, in response to a first scanning instruction, recognize a touch signal on a touchscreen in a first scanning mode;
within the same scanning cycle, in response to a second scanning instruction, determine whether the touch signal of the touchscreen has a corresponding ground signal in a second scanning mode; and
in response to a trigger area of the touch signal meeting a preset condition, and the touch signal corresponding to the ground signal, determine the touch signal as a target signal.

14. The device according to claim 13,
the first scanning mode is mutual capacitance scanning, and the second scanning mode is self-capacitance scanning.

15. The device according to claim 13, wherein within the scanning cycle, in response to a scanning instruction, the one or more processors are further configured to:
execute the first scanning mode and the second scanning mode in sequence; or
execute the second scanning mode and the first scanning mode in sequence.

16. The device according to claim 13, wherein:
the touchscreen includes a plurality of horizontal sensor lines and a plurality of vertical sensor lines;
each of the horizontal sensor lines and each of the vertical sensor lines are connected to a ground line and have a capacitance with the ground line; and
an intersection of a horizontal sensor line and a vertical sensor line is a sensor node.

17. The device according to claim 16, wherein the one or more processors is further configured to:
in response to the second scanning instruction, detect a capacitance value of a capacitance corresponding to each sensor line of the horizontal sensor lines and the vertical sensor lines;
in response to detecting a change in the capacitance value compared to a reference capacitance value, determine that the sensor line corresponding to the capacitance has the ground signal; and
in response to at least one sensor line corresponding to the touch signal having a ground signal, determine that the touch signal has the corresponding ground signal.

18. The device according to claim 16, wherein when a number of sensor nodes included in the trigger area is less than a preset number, the trigger area of the touch signal meets a preset condition.

19. The device according to claim 13, wherein the one or more processors are further configured to:
in response to a first operation mode start instruction, detect the target signal in the first scanning mode; and
in response to a second operation mode start instruction, detect the target signal in the first scanning mode and the second scanning mode.

20. The device according to claim 19, wherein the one or more processors are further configured to:
in response to a current operation mode being not a second operation mode, and detecting that a change amount of the capacitance value is smaller than a threshold, issue the second operation mode start instruction; or
obtain the second operation mode start instruction through a user interface.
